(19) United States
(12) Patent Application Publication
(10) Pub. No.: US 2021/0334681 A1
(43) Pub. Date: Oct. 28, 2021

(54) ELECTRONIC DEVICE AND METHOD FOR TURNOVER RATE PREDICTION

(71) Applicant: PEGATRON CORPORATION, TAIPEI CITY (TW)

(72) Inventors: Yuchi Liu, Taipei City (TW); Tingan Jiang, Taipei City (TW)

(73) Assignee: PEGATRON CORPORATION, TAIPEI CITY (TW)

(21) Appl. No.: 17/192,756

(22) Filed: Mar. 4, 2021

(30) Foreign Application Priority Data
Apr. 23, 2020 (TW) 109113664

(51) Int. Cl. G06N 5/04; G06N 20/00; G06Q 10/10

(52) U.S. Cl. CPC G06N 5/04; G06Q 10/105; G06N 20/00

(57) ABSTRACT

An electronic device and a method for turnover rate prediction are provided, wherein the method includes: receiving human resource (HR) data; generating a feature dataset according to the HR data; inputting a first subset of the feature dataset to a first machine learning (ML) model to generate a first prediction; inputting a second subset of the feature dataset to a second ML model to generate a second prediction; and inputting the first prediction, the second prediction, and a third subset of the feature dataset to a third ML model to generate a first turnover rate prediction.

### CROSS-REFERENCE TO RELATED APPLICATION

This application claims the priority benefit of Taiwan application no. 109113664, filed on Apr. 23, 2020. The entirety of the above-mentioned patent application is hereby incorporated by reference herein and made a part of this specification.

### TECHNICAL FIELD

The disclosure relates to an electronic device and a method, and more particularly, relates to an electronic device and a method for turnover rate prediction.

### BACKGROUND

At present, a human resource manager usually decides a human resource adjustment strategy based on a historical recruitment condition within the company and a subjective consciousness of the manager. If the historical recruitment condition of the company is unstable, the manager will not be able to evaluate an appropriate adjustment strategy. In addition to the company's own operating condition, the reasons for employee resignation are often affected by external factors from the company. For example, when the market releases a large number of high-paying job opportunities, even if the company's own operations are in good condition, the probability of employees asking for resignation will still increase. On the other hand, traditional human resource management methods can only predict a turnover rate of an employee based on historical data, but cannot dynamically re-predict the turnover rate of the employee based on changes in a bonus policy according to the new bonus policy.

### SUMMARY

The disclosure provides an electronic device and a method for turnover rate prediction, which can predict the turnover rate of the employee in the company based on human resource data.

The disclosure provides an electronic device for turnover rate prediction, which includes a processor, a storage medium and a transceiver. The storage medium stores a plurality of modules. The processor is coupled to the storage medium and the transceiver, and accesses and executes the plurality of modules. The modules include a data collecting module, a data mining module and a turnover rate estimation module. The data collecting module receives human resource data through the transceiver. The data mining module generates a feature dataset according to the human resource data. The feature dataset includes a first subset, a second subset and a third subset. The turnover rate estimation module inputs the first subset to a first machine learning model to generate a first prediction, inputs a second subset to a second machine learning model to generate a second prediction, and inputs the first prediction, the second prediction and the third subset to a third machine learning model to generate a first turnover rate prediction.

In an embodiment of the disclosure, the feature dataset further includes a fourth subset, and the plurality of modules further include a bonus policy simulation module. The bonus policy simulation module inputs a fourth subset of the feature dataset and a bonus policy to a fourth machine learning model to generate a third prediction, and inputs the third prediction and the bonus policy to a fifth machine learning model to generate a second turnover rate prediction.

In an embodiment of the disclosure, based on the bonus policy being updated, the bonus policy simulation module generates the updated second turnover rate prediction according to the updated bonus policy.

In an embodiment of the disclosure, the turnover rate estimation module performs a time series cross-validation on the first subset to generate the first prediction.

In an embodiment of the disclosure, the first subset includes a plurality of feature data. The turnover rate estimation module generates a plurality of combinations by pairing the plurality of feature data to respectively generate a plurality of performance indexes, selects a combination corresponding to a highest performance index from the plurality of combinations, and inputs the combination to the first machine learning model to generate the first prediction.

In an embodiment of the disclosure, the bonus policy simulation module performs a time series cross-validation on the fourth subset to generate the third prediction.

In an embodiment of the disclosure, the fourth subset includes a plurality of feature data. The bonus policy simulation module generates a plurality of combinations by pairing the plurality of feature data to respectively generate a plurality of performance indexes, selects a combination corresponding to a highest performance index from the plurality of combinations, and inputs the combination to the fourth machine learning model to generate the third prediction.

In an embodiment of the disclosure, the human resource data includes least one of basic employee information, check-in information, an internal recruitment policy, employee productivity information and a market bonus policy.

In an embodiment of the disclosure, the feature dataset includes an average daily capacity variation, an overall employee workload index, a proportion of people in each seniority interval, a job market bonus quote, a proportion of people able to receive bonus before a specific time point, a proportion of people able to receive bonus after the specific time point, a proportion of people not yet receiving bonus and a difference between a bonus of people not yet receiving bonus and a market bonus.

In an embodiment of the disclosure, the first machine learning model includes at least one of a linear regression model, a linear support vector regression model and a radial support vector regression model, and the third machine learning model includes a second linear regression model.

A method for turnover rate prediction of the disclosure includes: receiving human resource data; generating a feature dataset according to the human resource data; inputting a first subset of the feature dataset to a first machine learning model to generate a first prediction; inputting a second subset of the feature dataset to a second machine learning model to generate a second prediction; and inputting the first prediction, the second prediction, and a third subset of the feature dataset to a third machine learning model to generate a first turnover rate prediction.

In an embodiment of the disclosure, the method further includes: inputting a fourth subset of the feature dataset and a bonus policy to a fourth machine learning model to generate a third prediction, and inputting the third prediction and the bonus policy to a fifth machine learning model to generate a second turnover rate prediction.

In an embodiment of the disclosure, the method further includes: based on the bonus policy being updated, generating the updated second turnover rate prediction according to the updated bonus policy.

In an embodiment of the disclosure, the step of inputting the first subset of the feature dataset to the first machine learning model to generate the first prediction includes: performing a time series cross-validation on the first subset to generate the first prediction.

In an embodiment of the disclosure, the first subset includes a plurality of feature data, and the step of inputting the first subset of the feature dataset to the first machine learning model to generate the first prediction includes: generating a plurality of combinations by pairing the plurality of feature data to respectively generate a plurality of performance indexes; selecting a combination corresponding to a highest performance index from the plurality of combinations; and inputting the combination to the first machine learning model to generate the first prediction.

In an embodiment of the disclosure, the step of inputting the fourth subset of the feature dataset and the bonus policy to the fourth machine learning model to generate the third prediction includes: performing a time series cross-validation on the fourth subset to generate the third prediction.

In an embodiment of the disclosure, the step of inputting the fourth subset of the feature dataset and the bonus policy to the fourth machine learning model to generate the third prediction includes: generating a plurality of combinations by pairing the plurality of feature data to respectively generate a plurality of performance indexes; selecting a combination corresponding to a highest performance index from the plurality of combinations; and inputting the combination to the fourth machine learning model to generate the third prediction.

In an embodiment of the disclosure, the human resource data includes least one of basic employee information, check-in information, an internal recruitment policy, employee productivity information and a market bonus policy.

In an embodiment of the disclosure, the feature dataset includes an average daily capacity variation, an overall employee workload index, a proportion of people in each seniority interval, a job market bonus quote, a proportion of people able to receive bonus before a specific time point, a proportion of people able to receive bonus after the specific time point, a proportion of people not yet receiving bonus and a difference between a bonus of people not yet receiving bonus and a market bonus.

In an embodiment of the disclosure, the first machine learning model includes at least one of a linear regression model, a linear support vector regression model and a radial support vector regression model, and the third machine learning model includes a second linear regression model.

Based on the above, the disclosure can generate the turnover rate predictions through a machine learning model architecture with a hierarchical structure, so as to improve the accuracy of the turnover rate predictions.

### BRIEF DESCRIPTION OF THE DRAWINGS

FIG. 1 is a schematic diagram illustrating an electronic device for turnover rate prediction according to an embodiment of the disclosure.

FIG. 2 is a flowchart illustrating a method for turnover rate prediction according to an embodiment of the disclosure.

FIG. 3 is a schematic diagram illustrating a first turnover rate prediction generated according to a feature dataset according to an embodiment of the disclosure.

FIG. 4 is a schematic diagram illustrating a time series cross-validation performed on a specific combination in multiple combinations of the feature data according to an embodiment of the disclosure.

FIG. 5 is a schematic diagram illustrating a second turnover rate prediction generated according to a bonus policy according to an embodiment of the disclosure.

### DETAILED DESCRIPTION

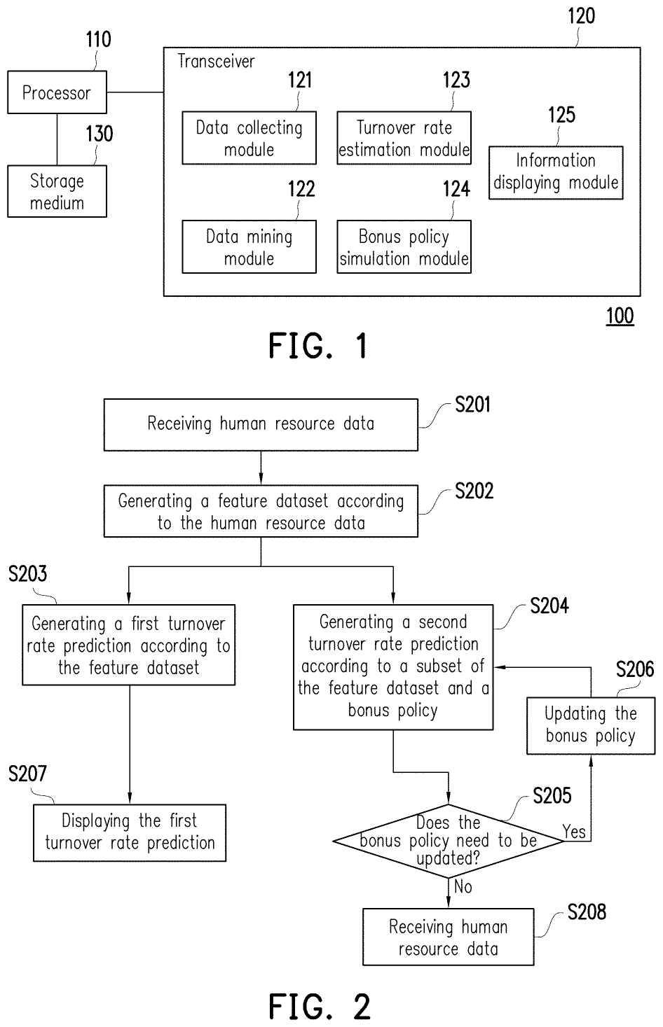

FIG. 1 is a schematic diagram illustrating an electronic device 100 for turnover rate prediction according to an embodiment of the disclosure. The electronic device 100 can include a processor 110, a storage medium 120 and a transceiver 130.

The processor 110 is, for example, a central processing unit (CPU) or other programmable micro control units (MCU) for general purpose or special purpose, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar elements or a combination of above-mentioned elements. The processor 110 can be coupled to the storage medium 120 and the transceiver 130, and can access or execute a plurality of modules and various applications stored in the storage medium 120.

The storage medium 120 is, for example, a random access memory (RAM), a read-only memory (ROM), a flash memory, a hard disk drive (HDD), a hard disk drive (HDD), a solid state drive (SSD) or other similar elements in any stationary or movable form, or a combination of the above-mentioned elements, and is used to store the modules and various applications that may be executed by the processor 110. In this embodiment, the storage medium 120 can store multiple modules including a data collecting module 121, a data mining module 122, a turnover rate estimation module 123, a bonus policy simulation module 124 and an information displaying module 125, and their functions will be described later.

The transceiver 130 transmits and receives signals in a wired or wireless manner. The transceiver 130 can also perform operations such as low noise amplifying, impedance matching, frequency mixing, up and down frequency conversion, filtering, amplification and similar operations.

FIG. 2 is a flowchart illustrating a method for turnover rate prediction according to an embodiment of the disclosure, and the method may be implemented by the electronic device 100 shown in FIG. 1.

In step S201, the data collecting module 121 can receive human resource data through the transceiver 130. For instance, the transceiver 130 can be communicatively coupled to an input device or a human machine interface. A user can upload the human resource data to the transceiver 130 through the input device or the human machine interface. The human resource data may include, for example, basic employee information, check-in information, an internal recruitment policy, employee productivity information or a market bonus policy, but the disclosure is not limited thereto.

In step S202, the data mining module 122 can generate a feature dataset according to the human resource data. For instance, the data mining module 122 can perform a data mining on the human resource data to generate the feature dataset. The feature dataset may include at least one feature data including an average daily capacity variation, an overall employee workload index, a proportion of people in each seniority interval, a job market bonus quote (e.g., the third quartile in job market bonus) or a bonus policy. Here, the bonus policy includes, for example, a proportion of people able to receive bonus before a specific time point, a proportion of people able to receive bonus after the specific time point, a proportion of people not yet receiving bonus and a difference between a bonus of people not yet receiving bonus and a market bonus, but the disclosure is not limited thereto.

The employee productivity information includes, for example, a productivity of a production line an employee is responsible for. The productivity will be affected by market conditions. When the market shrinks, a turnover rate of the employee will increase. In other words, the productivity is more difficult to effectively reflect the company's operating condition. Therefore, in order to reduce the influence of market conditions on the calculation of the turnover rate of one single employee, the data exploration module 122 can use the employee productivity information to calculate the average daily capacity variation of the employee. Compared with the productivity, the correlation between the average daily capacity variation and the turnover rate of the employee is more significant.

Employees who are about to leave often have frequent absenteeism. Accordingly, the data mining module 122 can use the check-in information of the employee to instantly determine whether the employee is frequently absent from work, so as to infer the probability of the employee's resignation. In addition, the data mining module 122 can also calculate working hours or overtime hours of the employee from the check-in information, so as to calculate the overall employee workload index based on the working hours or the overtime hours of each employee.

The current bonus policy is mostly based on the number of working days or a seniority of the employee to calculate a bonus. When the working days or the seniority of the employee reaches a threshold, the employee can receive the bonus. The peak of employee turnover often occurs within a period of time after the bonus has been distributed. Information such as a distribution time or an amount of the bonus will significantly affect the turnover rate of the employee. Therefore, the data mining module 122 can generate feature data significantly related to the turnover rate based on information like the basic employee data, the check-in information or the market bonus policy. The feature dataset includes, for example, the proportion of people in each seniority interval, the job market bonus quote (e.g., the third quartile in job market bonus), the proportion of people able to receive bonus before a specific time point (e.g., the proportion of people able to receive bonus within N days to the total of employees in the entire company, where N is any positive integer), the proportion of people able to receive bonus after the specific time point (e.g., the proportion of people able to receive bonus after N days but within M days to the total of employees in the entire company, where M is any positive integer greater than N), the proportion of people not yet receiving bonus and the difference between the bonus of people not yet receiving bonus and the market bonus.

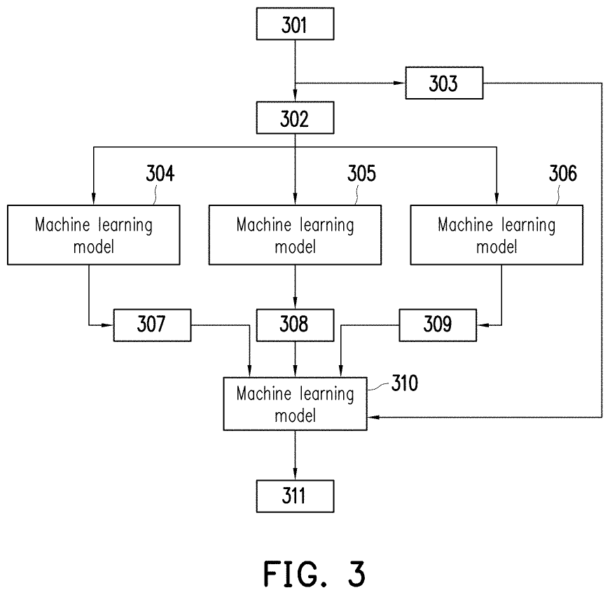

In step S203, the turnover rate estimation module 123 can generate a first turnover rate prediction according to the feature dataset. FIG. 3 is a schematic diagram illustrating a first turnover rate prediction 311 generated according to a feature dataset 301 according to an embodiment of the disclosure. The turnover rate estimation module 123 can input the feature dataset 301 to a plurality of machine learning models. In this embodiment, the machine learning models are, for example, three machine learning models including a machine learning model 304, a machine learning model 305 and a machine learning model 306, but the disclosure is not limited thereto. For example, the number of the machine learning models may be one, two or more than three.

The turnover rate estimation module 123 can input a subset 302 of the feature dataset 301 to the machine learning model 304 to generate a prediction 307. The machine learning model 304 is, for example, a linear regression model, a linear support vector regression (linear SVR) model or a support vector regression (radial SVR) model, but the disclosure is not limited thereto.

The subset 302 may include a plurality of feature data. During the training and application of the machine learning model 304, the turnover rate estimation module 123 can generate a plurality of combinations (e.g., a first combination containing the feature data such as the average daily capacity variation and the overall employee workload index, or a second combination containing the feature data such as the overall employee workload index, the proportion of people in each seniority interval and the job market bonus quote) by pairing the feature data to generate a plurality of performance indexes respectively corresponding to the combinations, and select a combination corresponding to a highest performance index from the combinations. The turnover rate estimation module 123 can train the machine learning model 304 according to the combination with the highest performance index, and input that combination to the trained machine learning model 304 to generate the prediction 307. The performance is, for example, related to elements in a confusion matrix, such as a recall rate, a precision, a miss rate, or an accuracy.

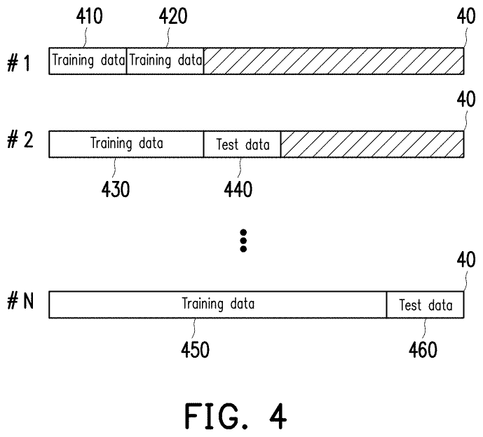

Specifically, the turnover rate estimation module 123 can first pair multiple feature data (e.g., multiple feature data included in the subset 302) to generate multiple combinations and perform a time series cross-validation on each of the combinations. FIG. 4 is a schematic diagram illustrating a time series cross-validation performed on a specific combination in multiple combinations of the feature data according to an embodiment of the disclosure.

When performing a first time series cross-validation #1, the turnover rate estimation module 123 can extract training data 410 and test data 420 from at least one feature data 40 corresponding to the specific combination in the combinations. Here, the training data 410 may be different from the test data 420. Then, the turnover rate estimation module 123 can use the training data 410 to train the machine learning model, and use the test data 420 to calculate a performance value of the machine learning model corresponding to the training data 410. Then, the turnover rate estimation module 123 can perform a second time series cross-validation #2.

When performing the second time series cross-validation #2, the turnover rate estimation module 123 can extract training data 430 and test data 440 from the at least one feature data 40 corresponding to the specific combination in the combinations. Here, the training data 430 may be different from the training data 410 and the test data 440, and the test data 440 may be different from the test data 420. Then, the turnover rate estimation module 123 can use the training data 430 to train the machine learning model, and use the test data 440 to calculate a performance value of the machine learning model corresponding to the training data 430. It should be noted that, in an embodiment, the training data corresponding to the current time series cross-validation may be a combination of the training data and the test data corresponding to the previous time series cross-validation. For instance, the training data 430 corresponding to the second time series cross-validation #2 may be a combination of the training data 410 and the test data 420 corresponding to the first time series cross-validation #1.

By analogy, after an N-th (N is any positive integer) time series cross-validation is performed by using training data 450 and test data 460, the turnover rate estimation module 123 can generate N performance values according to results of N time series cross-validations, and determine, according to the N performance values, the performance index of the machine learning model trained according to the specific combination.

Based on the same method having the steps of the time series cross-validation described above, the turnover rate estimation module 123 can generate multiple performance indexes corresponding to each of the combinations. Each of the combinations is a combination of one or more feature data (e.g., multiple feature data in the subset 302). The turnover rate estimation module 123 can select a best combination corresponding to a highest performance index from the combinations according to the performance indexes (e.g., a combination with a highest accuracy, and the combination includes one or more feature data). Next, the turnover rate estimation module 123 can train the machine learning model 304 according to at least one feature data corresponding to the best combination, and generate the prediction 307 by using the machine learning model 304. The turnover rate estimation module 123 can filter out at least one feature data that can significantly affect the turnover rate from a large number of feature data through the time series cross-validation and selection of the best combination. In this way, the amount of computation consumed by the machine learning model 304 can be greatly reduced.

Based on the same method for the machine learning model 304, the turnover rate estimation module 123 can input the subset 302 of the feature dataset 301 to the machine learning model 305 to generate a prediction 308. The machine learning model 305 is, for example, a machine learning model different from the machine learning model 304. Similarly, the turnover rate estimation module 123 can input the subset 302 of the feature dataset 301 to the machine learning model 306 to generate a prediction 309. The machine learning model 306 is, for example, a machine learning model different from the machine learning model 304 and the machine learning model 305. The subset 302 input to the machine learning model 304, the subset 302 input to the machine learning model 305, and the subset 302 input to the machine learning model 306 may be the same or different.

After generating the prediction 307, the prediction 308 and the result 309, the turnover rate estimation module 123 can input the prediction 307, the prediction 308, the prediction 309 and a subset 303 of the feature dataset 301 to the machine learning model 310. The subset 303 may be the same or different from the subset 302. The machine learning model 310 is, for example, a linear regression model, but the disclosure is not limited thereto. The machine learning model 310 can generate the first turnover rate prediction 311 according to the prediction 307, the prediction 308, the prediction 309 and the subset 303.

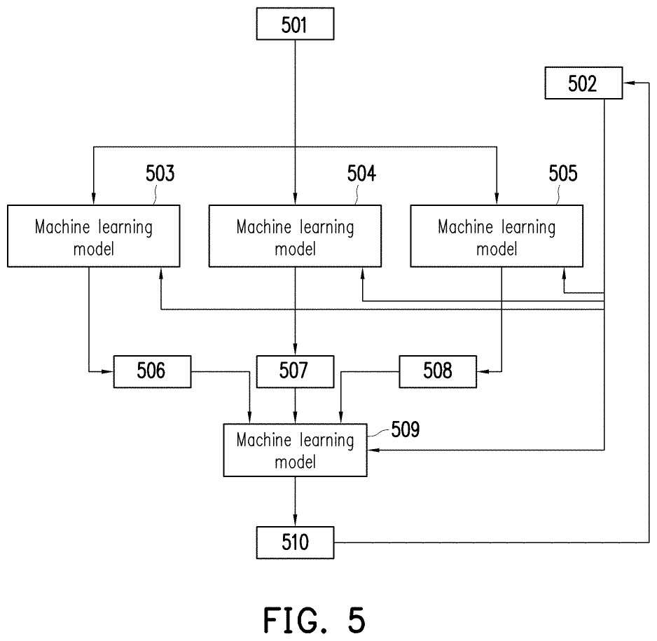

Returning to FIG. 2, in step S204, the bonus policy simulation module 124 can generate a second turnover rate prediction 510 according to a subset 501 of the feature dataset 301 and a bonus policy 502. Specifically, the bonus policy simulation module 124 can input the subset 501 of the feature dataset 301 and the bonus policy 502 (or the updated bonus policy 502) to a machine learning model 503 to generate a prediction 506 for calculating the second turnover rate prediction 510. The subset 501 may be the same or different from the subset 302 (or the subset 303). FIG. 5 is a schematic diagram illustrating the second turnover rate prediction 510 generated according to the bonus policy 502 (a raise, an extra bonus, an employee stock allotment or a dividend) according to an embodiment of the disclosure. The machine learning model 503 is, for example, a linear regression model, a linear support vector regression model or a support vector regression model, but the disclosure is not limited thereto.

The subset 501 of the feature dataset 301 may include a plurality of feature data. During the training and application of the machine learning model 503, the bonus policy simulation module 124 can generate a plurality of combinations (e.g., a first combination containing the feature data such as the average daily capacity variation, the overall employee workload index and the extra bonus, or a second combination containing the feature data such as the overall employee workload index, the proportion of people in each seniority interval, the job market bonus quote and the extra bonus) by pairing the feature data to generate a plurality of performance indexes respectively corresponding to the combinations, and select a combination corresponding to a highest performance index from the combinations. The bonus policy simulation module 124 can train the machine learning model 503 according to the combination with the highest performance index, and generate the second turnover rate prediction 510. The performance is, for example, related to elements in a confusion matrix, such as recall rate, precision, miss rate, or accuracy.

Specifically, the bonus policy simulation module 124 can pair multiple feature data in the subset 501 to generate multiple combinations and perform a time series cross-validation on each of the combinations as shown in FIG. 4. After the time series cross-validation is performed N times (N is any positive integer) on the specific combination in the combinations, the bonus policy simulation module 124 can generate N performance values according to results of N time series cross-validations, and determine, according to the N performance values, the performance index of the machine learning model trained according to the specific combination.

Based on the same method for the steps of the time series cross-validation described above, the bonus policy simulation module 124 can generate multiple performance indexes corresponding to each of the multiple combinations. Each of the combinations is a combination of one or more feature data. The bonus policy simulation module 124 can select the best combination corresponding to the highest performance index from the multiple combinations according to the performance indexes (e.g., a combination with a highest accuracy, and the combination includes one or more feature data). Next, the bonus policy simulation module 124 can train the machine learning model 503 according to at least one feature data corresponding to the best combination and the bonus policy 502 (or the updated bonus policy 502), and input the at least one feature data and the bonus policy (or the updated bonus policy 502) to the machine learning model 503 to generate the prediction 506. The bonus policy simulation module 124 can filter out at least one feature data that can significantly affect the turnover rate from a large number of feature data through the time series cross-validation and selection of the best combination. In this way, the amount of computation consumed by the machine learning model 503 can be greatly reduced.

Based on the same method for the machine learning model 503, the bonus policy simulation module 124 can input the subset 501 of the feature dataset 301 and the bonus policy 502 (or the updated the bonus policy 502) to a machine learning model 504 to generate a prediction 507. The machine learning model 504 is, for example, a machine learning model different from the machine learning model 503. Similarly, the bonus policy simulation module 124 can input the subset 501 of the feature dataset 301 and the bonus policy 502 (or the updated the bonus policy 502) to a machine learning model 505 to generate a prediction 508. The machine learning model 505 is, for example, a machine learning model different from the machine learning model 503 and the machine learning model 504. The subset 501 input to the machine learning model 503, the subset 501 input to the machine learning model 504, and the subset 501 input to the machine learning model 505 may be the same or different.

After generating the prediction 506, the prediction 507 and the result 508, the bonus policy simulation module 124 can input the prediction 506, the prediction 507, the prediction 508 and the bonus policy 502 (or the updated the bonus policy 502) to a machine learning model 509. The machine learning model 509 is, for example, a linear regression model, but the disclosure is not limited thereto. The machine learning model 509 can generate the second turnover rate prediction 510 according to the prediction 506, the prediction 507, the prediction 508 and the bonus policy 502 (or the updated the bonus policy 502). In an embodiment, the second turnover rate prediction 510 can serve as reference data for updating the bonus policy 502. The bonus policy simulation module 124 can update the bonus policy 502 according to the second turnover rate prediction 510.

Returning to FIG. 2, in step S205, the bonus policy simulation module 124 can determine whether to update the bonus policy 502. For instance, the bonus policy simulation module 124 can decide to update the bonus policy 502 in response to the second turnover rate prediction 510 indicating that the turnover rate is greater than the threshold, and decide not to update the bonus policy 502 in response to the second turnover rate prediction 510 indicating that the turnover rate is less than or equal to the threshold. If the bonus policy simulation module 124 decides to update the bonus policy 502, step S206 is entered. If the bonus policy simulation module 124 decides not to update the bonus policy 502, step S208 is entered.

In step S206, the bonus policy simulation module 124 can update the bonus policy 502. For instance, the bonus policy simulation module 124 can update the bonus policy 502 based on the second turnover rate prediction 510 according to a preset rule stored in the storage medium 120 or the trained machine learning model. On the other hand, whether to update the bonus policy 502 may also be determined by the user according to the second turnover rate prediction 510. For example, the user can input the updated bonus policy 502 to the electronic device 100 through an input device such as a keyboard or a touch screen. The electronic device 100 can receive the updated bonus policy 502 through the transceiver 130. After updating the bonus policy 502, the bonus policy simulation module 124 can re-execute step S204 according to the updated bonus policy 502. More specifically, after updating the bonus policy 502, the bonus policy simulation module 124 can train the machine learning model 503 (or the machine learning model 504, or the machine learning model 505) according to the at least one feature data corresponding to the best combination previously generated and the updated bonus policy 502.

In step S207, the information displaying module 125 can display the first turnover rate prediction 311. Specifically, the information displaying module 125 can transmit related information of the first turnover rate prediction 311 to an external output device (e.g., a display) through the transceiver 130, so as to display the first turnover rate prediction 311 through the external output device for the human resource manager to use as a reference for determining the human resource adjustment strategy.

In step S208, the information displaying module 125 can display the second turnover rate prediction 510. Specifically, the information displaying module 125 can transmit related information of the second turnover rate prediction 510 to the external output device (e.g., the display) through the transceiver 130, so as to display the second turnover rate prediction 510 through the external output device for the human resource manager to use as a reference for determining the human resource adjustment strategy.

In an embodiment, the information displaying module 125 can generate a comprehensive determination result corresponding to the first turnover rate prediction 311 and the second turnover rate prediction 510, transmit the comprehensive determination result to the external output device through the transceiver 130, and display the comprehensive determination result through the external output device for the human resource manager to use as a reference for determining the human resource adjustment strategy.

In summary, the disclosure can predict the employee turnover rate according to the prediction model based on artificial intelligence and big data. The disclosure can generate the turnover rate predictions through the machine learning model architecture with the hierarchical structure. In the turnover rate prediction, the disclosure not only considers the company's internal factors, but also considers the company's internal factors and the new bonus policy. In this way, the disclosure can improve the accuracy of the turnover rate predictions based on the big data including the company's internal and external factors, so that human resource managers can determine the best human resource adjustment strategy for the company based on the more accurate turnover rate predictions.

1. An electronic device for turnover rate prediction, comprising:
a transceiver;
a storage medium, storing a plurality of modules; and
a processor, coupled to the storage medium and the transceiver, and accessing and executing the plurality of modules, wherein the plurality of modules comprise:
a data collecting module, receiving human resource data through the transceiver;
a data mining module, generating a feature dataset according to the human resource data, wherein the feature dataset comprises a first subset, a second subset and a third subset; and
a turnover rate estimation module, inputting the first subset to a first machine learning model to generate a first prediction, inputting a second subset to a second machine learning model to generate a second prediction, and inputting the first prediction, the second prediction and the third subset to a third machine learning model to generate a first turnover rate prediction.

2. The electronic device of claim 1, wherein the feature dataset further comprises a fourth subset, and the plurality of modules further comprise:
a bonus policy simulation module, inputting the fourth subset and a bonus policy to a fourth machine learning model to generate a third prediction, and inputting the third prediction and the bonus policy to a fifth machine learning model to generate a second turnover rate prediction.

3. The electronic device of claim 2, wherein based on the bonus policy being updated, the bonus policy simulation module generates the updated second turnover rate prediction according to the updated bonus policy.

4. The electronic device of claim 1, wherein the turnover rate estimation module performs a time series cross-validation on the first subset to generate the first prediction.

5. The electronic device of claim 1, wherein the first subset comprises a plurality of feature data, and the turnover rate estimation module generates a plurality of combinations by pairing the plurality of feature data to respectively generate a plurality of performance indexes, selects a combination corresponding to a highest performance index from the plurality of combinations, and inputs the combination to the first machine learning model to generate the first prediction.

6. The electronic device of claim 2, wherein the bonus policy simulation module performs a time series cross-validation on the fourth subset to generate the third prediction.

7. The electronic device of claim 2, wherein the fourth subset comprises a plurality of feature data, and the bonus policy simulation module generates a plurality of combinations by pairing the plurality of feature data to respectively generate a plurality of performance indexes, selects a combination corresponding to a highest performance index from the plurality of combinations, and inputs the combination to the fourth machine learning model to generate the third prediction.

8. The electronic device of claim 1, wherein the human resource data comprises at least one of basic employee information, check-in information, an internal recruitment policy, employee productivity information and a market bonus policy.

9. The electronic device of claim 1, wherein the feature dataset comprises an average daily capacity variation, an overall employee workload index, a proportion of people in each seniority interval, a job market bonus quote, a proportion of people able to receive bonus before a specific time point, a proportion of people able to receive bonus after the specific time point, a proportion of people not yet receiving bonus and a difference between a bonus of people not yet receiving bonus and a market bonus.

10. The electronic device of claim 1, wherein the first machine learning model comprises at least one of a linear regression model, a linear support vector regression model and a radial support vector regression model, and the third machine learning model comprises a second linear regression model.

11. A method for turnover rate prediction, comprising:
receiving human resource data;
generating a feature dataset according to the human resource data;
inputting a first subset of the feature dataset to a first machine learning model to generate a first prediction;
inputting a second subset of the feature dataset to a second machine learning model to generate a second prediction; and
inputting the first prediction, the second prediction, and a third subset of the feature dataset to a third machine learning model to generate a first turnover rate prediction.

12. The method of claim 11, further comprising:
inputting a fourth subset of the feature dataset and a bonus policy to a fourth machine learning model to generate a third prediction, and inputting the third prediction and the bonus policy to a fifth machine learning model to generate a second turnover rate prediction.

13. The method of claim 12, further comprising:
based on the bonus policy being updated, generating the updated second turnover rate prediction according to the updated bonus policy.

14. The method of claim 11, wherein the step of inputting the first subset of the feature dataset to the first machine learning model to generate the first prediction comprises:
performing a time series cross-validation on the first subset to generate the first prediction.

15. The method of claim 11, wherein the first subset comprises a plurality of feature data, and the step of inputting the first subset of the feature dataset to the first machine learning model to generate the first prediction comprises:
generating a plurality of combinations by pairing the plurality of feature data to respectively generate a plurality of performance indexes;
selecting a combination corresponding to a highest performance index from the plurality of combinations; and
inputting the combination to the first machine learning model to generate the first prediction.

16. The method of claim 12, wherein the step of inputting the fourth subset of the feature dataset and the bonus policy to the fourth machine learning model to generate the third prediction comprises: performing a time series cross-validation on the fourth subset to generate the third prediction.

17. The method of claim 12, wherein the fourth subset comprises a plurality of feature data, and the step of inputting the fourth subset of the feature dataset and the bonus policy to the fourth machine learning model to generate the third prediction comprises:
generating a plurality of combinations by pairing the plurality of feature data to respectively generate a plurality of performance indexes;
selecting a combination corresponding to a highest performance index from the plurality of combinations; and
inputting the combination to the fourth machine learning model to generate the third prediction.

18. The method of claim 11, wherein the human resource data comprises at least one of basic employee information, check-in information, an internal recruitment policy, employee productivity information and a market bonus policy.

19. The method of claim 11, wherein the feature dataset comprises an average daily capacity variation, an overall employee workload index, a proportion of people in each seniority interval, a job market bonus quote, a proportion of people able to receive bonus before a specific time point, a proportion of people able to receive bonus after the specific time point, a proportion of people not yet receiving bonus and a difference between a bonus of people not yet receiving bonus and a market bonus.

20. The method of claim 11, wherein the first machine learning model comprises at least one of a linear regression model, a linear support vector regression model and a radial support vector regression model, and the third machine learning model comprises a second linear regression model.
